(19) United States
(12) Patent Application Publication
(10) Pub. No.: US 2025/0158364 A1
(43) Pub. Date: May 15, 2025

(54) CABLE STRIPPING DEVICE

(71) Applicant: Komax SLE GmbH & Co. KG, Grafenau (DE)

(72) Inventor: Eduard Albach, Zwiesel (DE)

(21) Appl. No.: 18/939,852

(22) Filed: Nov. 7, 2024

(30) Foreign Application Priority Data
Nov. 9, 2023 (EP) 23208854

(51) Int. Cl. H02G 1/12

(52) U.S. Cl. CPC H02G 1/1265; H02G 1/127

(57) ABSTRACT

A cable stripping device (1) includes a base module (10) and a blade cassette (20) having a blade carrier (21) and a cutting blade (23) for cutting into insulation of a cable. The blade carrier and a first drive shaft (8) of the base module include at least one attachment device (12, 28) that detachably attaches the blade carrier to the first drive shaft. The cutting blade or a second drive shaft (9) of the base module has a guide slot (26) for engaging a guide element (11) provided on the other of the cutting blade or the second drive shaft. The cutting blade is pivotable towards and away from the rotational axis (x) by rotation of the second drive shaft relative to the first drive shaft and to the blade carrier and by a resulting movement of the guide element along the guide slot relative to the blade carrier.

### CROSS-REFERENCE

The present application claims priority to European patent application serial number 23 208 854.9 filed on Nov. 9, 2023, the contents of which are incorporated fully herein by reference.

### TECHNICAL FIELD

The present invention relates to a cable stripping device for stripping cables, a base module for a cable stripping device, a blade cassette for a cable stripping device, a calibration station for a blade cassette, a system including a cable stripping device, a calibration station and a plug gauge, a mounting aid for a cable stripping device, as well as a system including a cable stripping device and a mounting aid.

### BACKGROUND ART

Cable ends are stripped and connected to contact parts to produce cable plug connections. For this purpose, an insulation (i.e. an insulation layer or jacket) at the cable end is severed, e.g., with a blade, and stripped away from a core of the cable. The stripping usually takes place automatically in production systems with the help of appropriate stripping devices.

A typical stripping device usually has two blades that are moved translationally towards each other to cut parts of the insulation of a cable. Thus, an uncut part of the insulation, which is torn when the insulation is stripped, often remains, which is acceptable for non-critical applications.

An improvement thereof is profiled blades, which are designed for a desired cutting contour. Such profiled blades provide a better cutting result, but are usable only in a limited manner with regard to their range of applications owing to differing cable sizes and cutting depths.

Units having rotating blades are used to provide a good cutting result with a larger application range. Such blades are not only moved towards each other, but are also moved around the circumference of the cable in a rotational movement, as disclosed, e.g., in EP 4 102 660 A1 or EP 3 895 267 A1. Thus, it is ensured that the incision into the cable takes place completely around the circumference.

Additional stripping devices are disclosed, for example, in DE 20 2008 017 576 U1, CN 106607953 A, CN 110829288 A, CN 111063492 A, CN 212182984 U, US 2018/0090918 A1, US 2020/0076174 A1 and WO 2020/119916 A1.

However, the additional rotational movement when using rotating blades requires a more complex mechanism than in typical stripping devices having only translational movement of the blades. This makes maintenance or conversion more complex, which has, e.g., a detrimental effect on the productivity of the corresponding system due to unproductive downtimes.

### SUMMARY OF THE INVENTION

It is therefore one non-limiting object of the present disclosure to disclose techniques for improving productivity in cable stripping operations.

In one non-limiting aspect of the present disclosure, a cable stripping device (or simply “stripping device” hereinbelow) for stripping cables may include a base module having a housing and two (first and second) drive shafts that are supported on the housing, extend coaxially in one another and are rotatable relative to the housing and to one another. The cable stripping device may further include a blade cassette having a blade carrier that is detachably attachable to an end of the first drive shaft of the base module, and at least one cutting blade that has a cutting edge facing in the direction of (towards) the rotational axis for cutting into an insulation (e.g., insulation layer or jacket) of the cable. The cutting blade is attached to the blade carrier at a pivot point in order to be pivotable about a pivot axis that is parallel to the rotational axis. The blade carrier and the first drive shaft preferably further include attachment means for detachably attaching the blade carrier to the first drive shaft at a predetermined rotational position relative to the first drive shaft. The cutting blade or the second drive shaft preferably has a guide slot configured to engage a guide element that is provided on the other of the cutting blade and the second drive shaft. In addition, the cutting blade is pivotable towards the rotational axis and away from the rotational axis in response to (i) rotation of the second drive shaft relative to the first drive shaft and to the blade carrier and (ii) a resulting movement of the guide element along the guide slot relative to the blade carrier.

Because the blade cassette can be prepared and attached to or removed from the base module or a machine as a unit, it can be changed quickly. Furthermore, the blade cassette can be prepared, e.g., using a calibration station, in particular while the base module and/or the cable stripping device is carrying out another production job using a different blade cassette.

The blade cassette is quickly and easily attachable to and removable from the base module. The base module need not be dismantled to attach or remove the blade cassette. In particular, the blade cassette can be attached and removed without dismantling parts of the base module, such as the first and second drive shafts. The drive shafts and their support on the housing of the base module can remain unchanged during attachment and removal of the blade cassette. Preferably, the drive shafts maintain their support (position) when the blade cassette is removed from the base module. This enables a quick and easy replacement of the blade cassette and shortens downtimes.

The first and second drive shafts can be supported in one another. For example, the first drive shaft can be supported directly on the housing of the base module, while the second drive shaft can be supported on (in) the first drive shaft and thus indirectly on the housing. Alternatively, both drive shafts can be supported directly or indirectly on the housing. A through hole can be provided in the second drive shaft along the common rotational axis for passage of a cable to be processed (stripped). The through hole can be coaxial with a through hole in the blade cassette, in particular with a through hole in the blade carrier and a through hole in the cover plate.

The end of the first output shaft, on which the blade carrier is detachably attachable, can, for example, be a flat and/or annular surface that is perpendicular to the rotational axis. In particular, it can be an end surface of the first output shaft. The surface can be formed on a flange that extends outwards. Driver pins can be provided on the surface.

The second output shaft can have a flat end surface that faces in the direction of the blade carrier and is perpendicular to the rotational axis. Guide pins can be provided on this surface. The end surfaces of the first and second output shafts can lie in the same plane or in planes parallel to each other.

The first and second drive shafts can protrude through a portion of the housing of the base module, in particular through a portion on which they are supported. The drive (e.g., electric motors) of the drive shafts can be provided on a first side of the portion of the housing; the portion of the first and second drive shafts, which is provided (designed, configured) for attaching the blade cassette, can be provided on a second side of the portion of the housing that is opposite of the first side.

The blade cassette or blade carrier is preferably supported only by the drive shafts, but not directly on the housing of the base module. This enables a simple and advantageous design and a simple and quick attachment and removal of the blade cassette.

To adjust the pivot positions of the cutting blades, the first and second drive shafts are rotated relative to each other. Depending on the direction of the relative rotation, the cutting blades are pivoted towards the through hole in the blade cassette, which is formed by the through hole in the blade carrier and the through hole in the cover plate, i.e. in the direction towards a cutting position, or away from it, i.e. in the direction towards a home (initial) position. To rotate the blade cassette with unchanged positions, i.e. pivot positions, of the cutting blades, the first and second drive shafts are rotated synchronously in the same direction and at the same speed. Relative rotation can also take place during the rotation of both drive shafts, in that one drive shaft rotates at a different speed than the other, so that the position of the cutting blades or the cutting depth is changed during the cutting process, i.e. during the rotation of the blade cassette around the cable to be processed (stripped). After the cutting process, the cutting blades can, for example, initially remain in the cutting position while the cable is pulled out of the through hole of the blade cassette, so that the cut-off portion of the insulation is removed from the core of the cable by the cutting blades. The cutting blades can then be pivoted back to the home position and are available for a new stripping process.

The driver pins enable a secure form-fit attachment of the blade cassette on the base module. The driver pins ensure that the blade cassette is correctly positioned and is rotated around the cable to be processed (stripped). The driver pins enable a quick and easy attachment and removal of the blade cassette to and from the end of the first drive shaft. An embodiment of the blade cassette having the disk-shaped blade carrier and the disk-shaped cover plate has a compact shape that can be easily manipulated and stored. The cutting blades can be located between the blade carrier and the cover plate and are therefore protected.

The equipping of the blade cassette having cutting blades, i.e. the number and/or positions of the cutting blades that are supported by the blade carrier, can vary depending on the cable to be processed (stripped). The same blade carrier can be equipped with different numbers and/or positions of cutting blades. For delicate cuts (e.g., cables having a shielding foil), fewer cutting blades, e.g. two or three, are preferably used, in order to bring into engagement a little more of the cutting edge (cut edge). For cutting and especially for subsequent stripping of thicker cable parts having stronger adhesion (e.g. cables having a cable sheath or inner dielectric), a larger number of cutting blades (e.g., four or six) is preferably used, whereby the service life of the cutting blades is increased, and during stripping the multiple contact points prevent a slipping way of the cable portion to be stripped and an excessive stress on the cutting blades.

A central pin of a mounting aid can hold the cutting blades in their home position, thus facilitating assembly and minimizing the complexity of the mechanism of the blade cassette, since, e.g., no return springs are required. Alternatively/additionally, the cutting blades can be pretensioned by return springs or other elastic means, e.g. in the direction of the home position.

With the aid of a calibration station, it can be ensured that the cutting blades reliably reach and do not exceed a desired cutting depth. In particular, the calibration station can perform the calibration of the blade cassette independently of (separate from) the base module.

### BRIEF DESCRIPTION OF THE DRAWINGS

Further objects, features, advantages and utilities will be understood from the following description of exemplary embodiments with reference to the figures, in which:

FIG. 1 shows a perspective view of a system having a cable stripping device, a calibration station and a plug gauge,

FIG. 2 shows a perspective exploded view of the cable stripping device,

FIG. 3 shows a perspective view of the calibration station with the blade cassette and the plug gauge attached to it,

FIG. 4 shows a perspective exploded view of the calibration station, the blade cassette and the plug gauge,

FIG. 5a and FIG. 5b respectively show a front view of a blade carrier having three or six cutting blades attached to it,

FIG. 6a and FIG. 6b respectively show a front view of a blade carrier having two or four cutting blades attached to it,

FIG. 7 shows a perspective exploded view of a first modification of the mounting aid shown in the cable stripping device of FIGS. 1 and 2,

FIG. 8 shows a perspective exploded view of a second modification of the mounting aid shown in the cable stripping device of FIGS. 1 and 2,

FIG. 9 shows a perspective exploded view of a third modification of the mounting aid shown in the cable stripping device of FIGS. 1 and 2,

FIG. 10 shows the cable stripping device of FIG. 9 in a state in which the mounting aid is mounted on the cable stripping device, and

FIG. 11a shows the mounting aid of FIGS. 9 and 10 in a non-expanded state and FIG. 11b shows the mounting aid of FIGS. 9 and 10 in an expanded state.

### DETAILED DESCRIPTION OF THE EMBODIMENTS OF THE INVENTION

An embodiment is described below with reference to the figures. Identical features are denoted with the same reference symbols in all figures, wherein all reference symbols are not used in all figures for reasons of clarity.

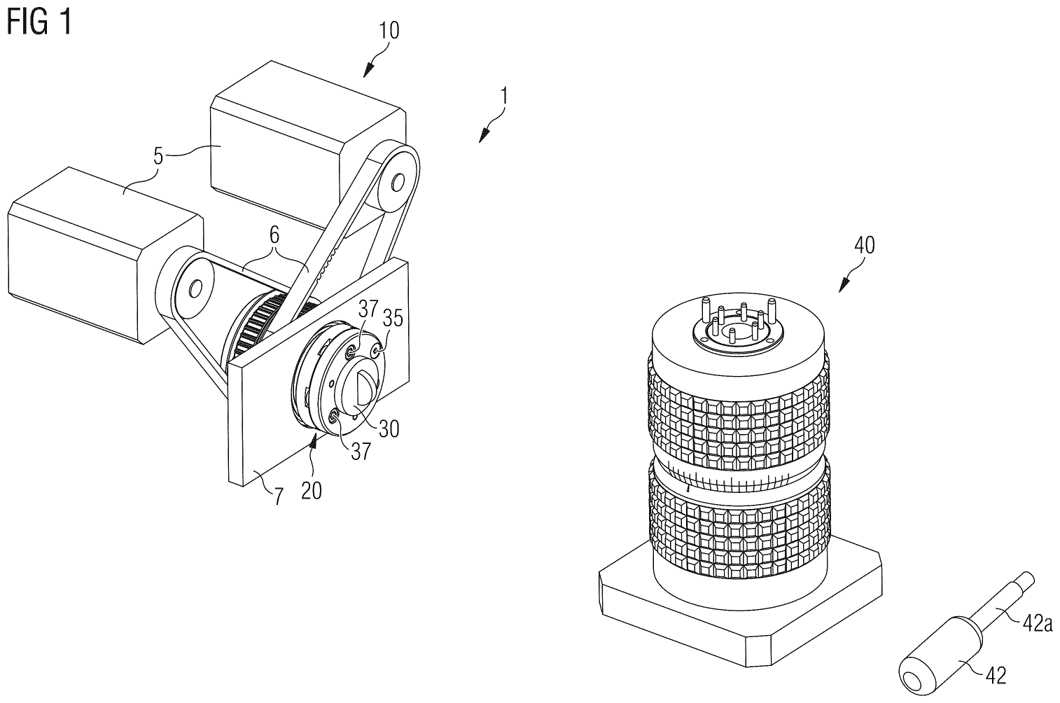

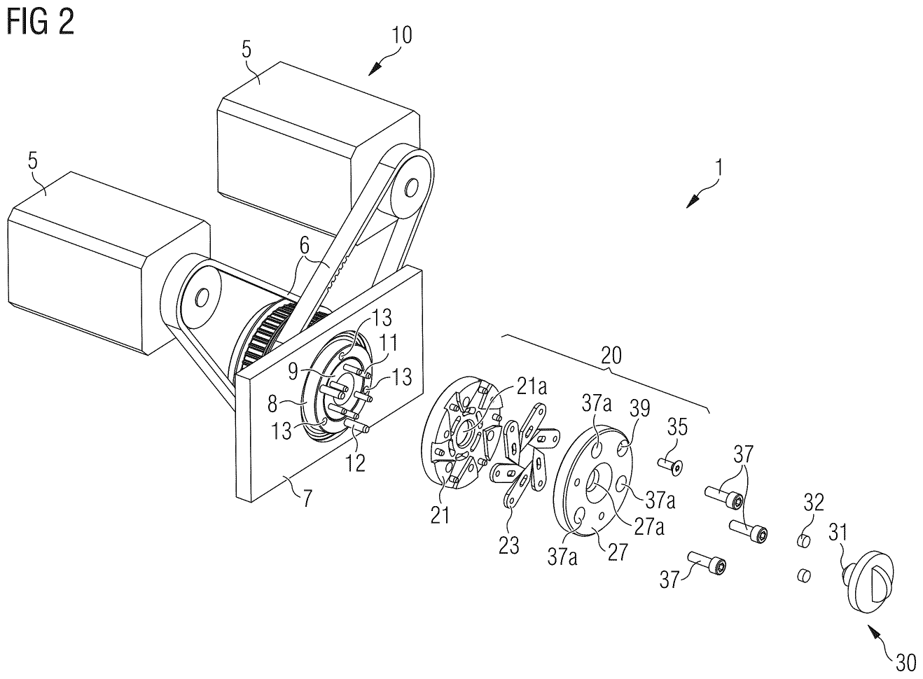

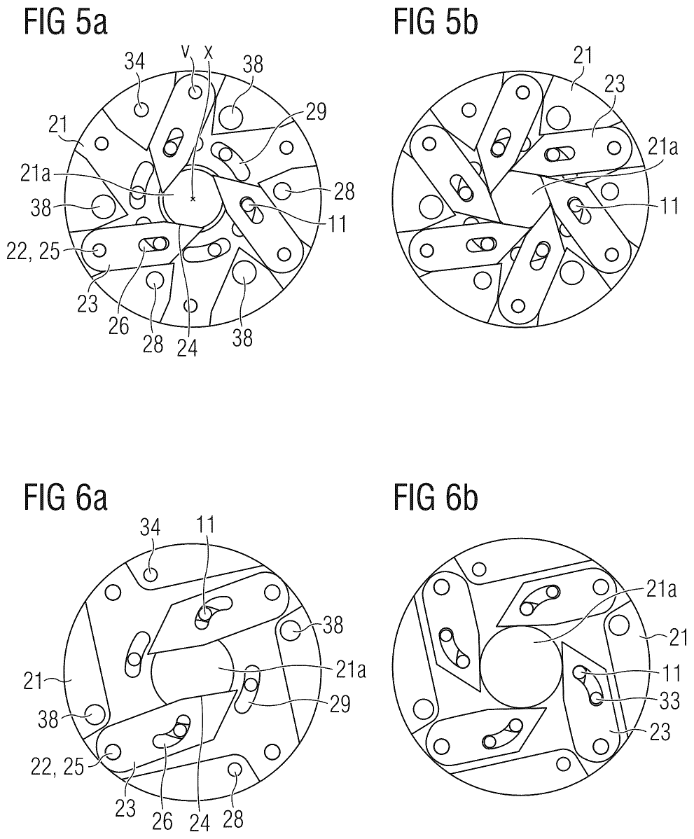

FIG. 1 shows a perspective view of a system having a cable stripping device 1 (hereinbelow, simply “stripping device”), a calibration station 40 and a plug gauge 42. FIG. 2 shows a perspective exploded view of the stripping device 1. The stripping device 1 includes a base module 10 having a housing 7 and two (i.e. first and second) drive shafts 8, 9 supported on the housing 7, as well as a blade cassette 20. The drive shafts 8, 9 extend in each other, e.g., in a nested and/or collinear manner. More precisely, the second drive shaft 9 extends inside the first drive shaft 8. The first and second drive shafts 8, 9 are each configured as a hollow shaft. Alternatively, the second drive shaft 9 can be configured as a solid shaft, i.e. without a central through hole. The first and second drive shafts 8, 9 extend coaxially. The first and second drive shafts 8, 9 are rotatable around a common rotational axis x (see FIG. 5a). The stripping device 1 includes two drive motors 5. The first and second drive shafts 8, 9 are each rotatable by one of the two drive motors 5 via a drive belt 6, as can be seen in FIG. 1.

The end surfaces are perpendicular to the rotational axis x and point in the same direction. On the end surface of the first drive shaft 8, driver pins 12 (in the present embodiment, two), which project from the end surface of the first drive shaft 8 parallel to the rotational axis x, are provided. Three threaded holes 13 are provided in the end surface of the first drive shaft 8. On the end surface of the second drive shaft 9, guide pins 11 (in the present embodiment six), which project from the end surface of the second drive shaft 9 parallel to the rotational axis x, are provided.

The blade cassette 20 includes a blade carrier 21, cutting blades 23 (in the present embodiment six) pivotably attached to the blade carrier 21 and a cover plate 27. FIG. 5a and FIG. 5b each show a front view of the blade carrier 21, wherein only three of the six cutting blades 23 are attached to the blade carrier 21 in the configuration shown in FIG. 5a. That is, the blade carrier 21 is configurable with different numbers and/or positions of the cutting blades 23. The blade carrier 21 is, in essence, configured as a circular disk. The blade carrier 21 has a central through hole 21a for the passage of a cable to be processed (stripped). The blade carrier 21 has bearing pins 22 (in the present embodiment six) for pivotably supporting the cutting blades 21. The bearing pins 22 project parallel to the rotational axis x of the blade carrier 21. The blade carrier 21 has recesses in which the cutting blades 23 are disposed. The blade carrier 21 has mounting holes 28 (in the present embodiment two). The (two) mounting holes 28 are configured to respectively receive the (two) driver pins 12, so that the blade carrier 21 can be attached to the first drive shaft 8 of the base module 10 at a specific rotational position. The blade carrier 21 has slotted holes 29 (in the present embodiment six). The slotted holes 29 are configured such that, in a state in which the blade carrier 21 is attached to the first drive shaft 8, the guide pins 11 extend through the slotted holes 29 and are movable along the slotted holes 29, so that the blade carrier 21 is rotatable relative to the second drive shaft 9 of the base module 10, on which the guide pins 11 are provided, within a range defined by the slotted holes 29. In particular, the slotted holes 29 are curved and extend along a circle around the rotational axis x. The blade carrier 21 has a threaded hole 34 (in the present embodiment one). The blade carrier 21 has through holes 38 (in the present embodiment three).

The cutting blades 23 have, in essence, an identical design. Therefore, only one of the cutting blades 23 will be described below in an exemplary manner. The cutting blade 23 has, in essence, an elongated plate shape. The cutting blade 23 has a hole 25 at one end in its longitudinal direction. The hole 25 is configured to receive one of the bearing pins 22 on the blade carrier 21, so that the cutting blade 23 is pivotably supported on the blade carrier 21 about a pivot axis v relative to the blade carrier 21 in a plane perpendicular to the rotational axis x. In other words, the hole 25 and the bearing pin 22 define a pivot point, at which the cutting blade 23 is pivotably attached to the blade carrier 21. The cutting blade 23 has a slotted hole 26. The slotted hole 26 is configured to receive one of the guide pins 11. The guide pin 11 is movable along the slotted hole 26. The slotted hole 26 can be straight (see FIGS. 5a and 5b) or curved (see FIGS. 6a and 6b). In a state in which the cutting blade 23 is mounted on the blade carrier 21, a portion of the slotted hole 26 in the cutting blade 23 overlaps with a portion of an underlying slotted hole 29 in the blade carrier 21. In particular, the slotted hole 26 can have a different curvature and/or orientation than the slotted holes 29 in the blade carrier 21. The cutting blade 23 has a cutting edge 24. In the state mounted on the blade carrier 21, the cutting edge 24 is provided on a side of the cutting blade 23 that faces the through hole 21a in the blade carrier 21; i.e. it faces the rotational axis x (radially inward).

The blade carrier 21 is rigidly attachable to the first drive shaft 8 using the driver pins 12 and the attachment holes 28, i.e. at a fixed, predetermined rotational position. The driver pins 12 and the attachment holes 28 serve as one non-limiting example of an attachment means according to the present disclosure. In a state in which the blade carrier 21 is attached to the first drive shaft 8, the guide pins 11 on the second drive shaft 9 extend through the slotted holes 29 in the blade carrier 21 and are inserted into the slotted holes 26 in the cutting blades 23 mounted on the blade carrier 21. During rotation of the second drive shaft 9 relative to the first drive shaft 8, the guide pins 11 move within the slotted holes 29 relative to the blade carrier 21. Due to this movement, the guide pins 11 move within the slotted holes 26 of the cutting blades 23 and pivot the cutting blades 23 about the respective pivot axes v. Thus, the cutting edges 24 of the cutting blades 23 can be pivoted towards or away from the through hole 21a/rotational axis x by a relative rotation of the second drive shaft 9 with respect to the first drive shaft 8, depending on the direction of the relative rotation. During pivoting towards the through hole 21a/rotational axis x due to a relative rotation of the second drive shaft 9 with respect to the first drive shaft 8 in a first direction, the cutting blades 23 are pivoted to a cutting position in which the cutting edges 24 of the cutting blades 23 can cut into the insulation (e.g., shielding foil, insulation layer or jacket) of a cable inserted into the through hole 21a. With subsequent or simultaneous mutual rotation of the first and second drive shafts 8, 9 about the rotational axis x, the cutting blades 24 can evenly cut the insulation of the cable around a core of the cable. The cut part of the insulation can then be removed from the cable, e.g., stripped, by moving the cable relative to the stripping device 1 along the rotational axis x. Thereafter, by rotating the second drive shaft 9 relative to the first drive shaft 8 in a second direction that is opposite to the first direction, the cutting blades 23 can be pivoted away from the through hole 21a/rotational axis x or the cable back to the home position after the cutting process, so that the processed cable can be removed from the through hole 21a and a new cable can be inserted.

The number of cutting blades 23 can be selected depending on the application, in particular on the cable to be processed (stripped). One to six cutting blades 23 can be attached to the blade carrier 21 shown in FIGS. 5a and 5b. A rotationally symmetrical arrangement of the cutting blades 23 having two or three (FIG. 5a) or six (FIG. 5b) cutting blades 23 is preferred.

The blade carrier 21 can have an alternative design, as shown, for example, in FIGS. 6a and 6b. One to four cutting blades 21 can be attached to the blade carrier 21 shown in FIGS. 6a and 6b. Again, a rotationally symmetrical arrangement of the cutting blades 23 with two (FIG. 6a) or four (FIG. 6b) cutting blades 23 is preferred. When using the blade carrier 21 shown in FIGS. 6a and 6b, the number and/or the positions of the driver pins 12 and the guide pins 11 may have to be adapted to the number and/or the positions of the mounting holes 28 in the blade carrier 21 or to the number and/or the positions of the slotted holes 26, 29. The number and/or positions of the threaded holes 13 may have to be adapted to the number and/or position of the through holes 38.

The cover plate 27 is, in essence, configured as a circular disk. The cover plate 27 has a central through hole 27a for passage of the cable. The cover plate 27 has a through hole 39. The cover plate 27 is screw-fastened to the blade carrier 21 with a screw 35. More specifically, the screw 35 is inserted into the through hole 39 and screwed into the threaded hole 34 of the blade carrier 21. The cutting blades 23 are disposed between the blade carrier 21 and the cover plate 27. The cover plate 27 has through holes 37a (in the present embodiment three). The through holes 37a are arranged at positions corresponding to the through holes 38 of the blade carrier 21 and the threaded holes 13 of the first drive shaft 8 of the base module 10. The blade cassette 20 is screw-fastened to the first drive shaft 8 with screws 37. The screws 37 extend through the through holes 37a and 38 and are screwed into the threaded holes 13.

FIG. 1 shows a state in which a mounting aid (e.g., a pin with handle or grip) 30 is attached to the blade cassette 20. A pin 31 of the mounting aid 30 is inserted along the rotational axis x into the through hole 27a of the cover plate 27, into a space formed between the cutting edges 24 of the cutting blades 23 and into the through hole 21a of the blade carrier 21. The blade cassette 20 can be removed from the base module 10 using the mounting aid 30 attached to the blade cassette 20 while the cutting blades 23 are held in their position, e.g., in the home position, by the pin 31. The mounting aid 30 is held on the blade cassette 20, in particular on the cover plate 27, e.g., by two magnets 32, although of course different numbers of magnets 32 may be employed for this purpose. Alternate fastening means may be utilized as the mounting aid 30, as will be described below.

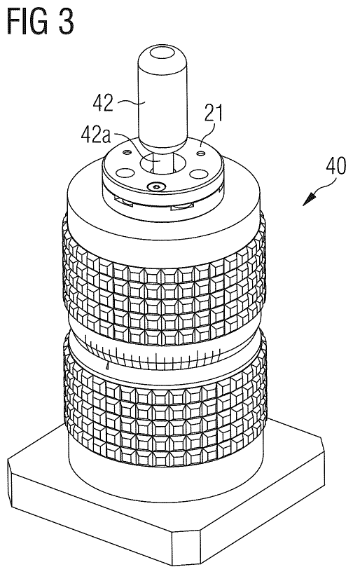

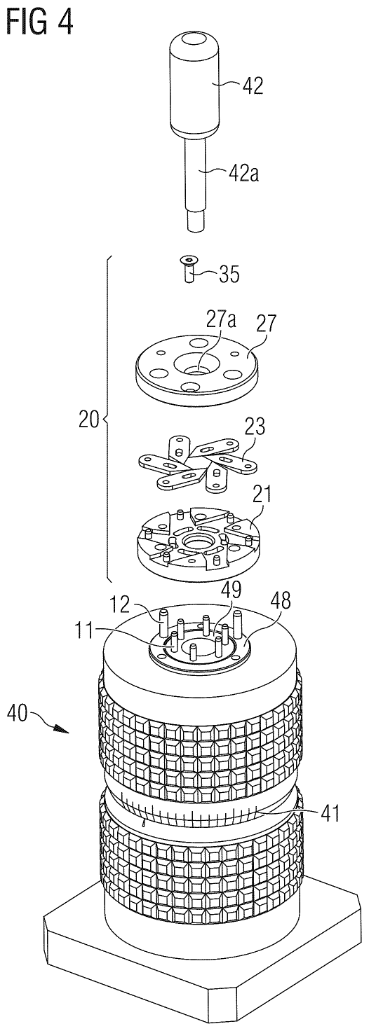

After removal from or before attachment to the base module 10, the blade cassette 20 can be attached to the calibration station 40 for calibration purposes, as shown in FIG. 3. FIG. 4 shows a corresponding exploded view.

The calibration station 40 has a first shaft 48 and a second shaft 49, analogous to the first and second drive shafts 8, 9 of the base module 10. The second shaft 49 extends inside the first shaft 48. The first shaft 48 is configured as a hollow shaft. The first shaft 48 can be an integral portion of a housing of the calibration station 40. For example, the first shaft 48 can be integrally formed with an upper housing portion of the calibration station 40 (i.e. without a seam therebetween, e.g., the first shaft 48 may be formed of the same material as the upper housing portion or of different materials that are fusible), and/or the second shaft 49 can be integrally formed with a lower housing portion of the calibration station 40 (i.e. without a scam therebetween e.g., the second shaft 49 may be formed of the same material as the lower housing portion or of different materials that are fusible). The first and second shafts 48, 49 are coaxially aligned and rotatable relative to each other. Analogous to the first drive shaft 8 of the base module 10, the first shaft 48 has two driver pins 12. Analogous to the second drive shaft 9, the second shaft 49 has six guide pins 11. The calibration station 40 includes a scale 41 that shows the rotational position of the second shaft 49 relative to the first shaft 48.

In the illustration in FIG. 3, the plug gauge 42 is inserted into the blade cassette 20 attached to the calibration station 40. In particular, a rod-shaped portion 42a of the plug gauge 42, which has a circular cross-section similar to the pin 31 of the mounting aid 30, is inserted into the through hole 27a of the cover plate 27, into the space formed between the cutting edges 24 of the cutting blades 23 and into the through hole 21a of the blade carrier 21. The rod-shaped portion 42a has a diameter identical to or similar to the diameter of the core of the cable to be processed (stripped). By rotating the first and second shafts 48, 49 relative to each other, the cutting blades 23 of the blade cassette 20 attached to the calibration station 40 can be pivoted towards the rod-shaped section 42a in the direction of the cutting position until the cutting blades 24 are in contact with the rod-shaped section 42a. In this state, the rotational position of the second shaft 49 relative to the first shaft 48 can be read from the scale 41 and stored, e.g., as a calibration value or parameter in a control device of the base module 10 or in a higher-level machine or system. In this way, the blade cassette 20 can be calibrated quickly and easily before attachment to the base module 10.

Depending on the usage and blade contour, such as a straight or a curved contour, one plug gauge 42 can be used or several plug gauges 42 having different diameters of the rod-shaped section 42a can be used.

The blade cassette 20 can be calibrated independently of (separate from) the base module 10. In particular, the blade cassette 20 can be calibrated while the base module 10 is operating with a second blade cassette currently attached to it. The second blade cassette can, e.g., be removed from the base module 10 using a second mounting aid. Immediately afterwards, the blade cassette 20, which has now been calibrated and removed from the calibration station 40 using the mounting aid 31, can be attached to the base module 10. After the ascertained calibration values have been communicated to the control unit, the production can be continued using the blade cassette 20 while the second blade cassette is, e.g., serviced and/or recalibrated. Thus, downtimes can be shortened.

In the embodiment shown, the cover plate 27 is fastened to the blade carrier 21 using the screw 35. Two or more screws 35 can also be provided. Alternatively/additionally, other fastening means can be used.

Instead of or in addition to a mounting aid 30 having a pin 31 and a handle as shown in FIG. 2, the mounting aid 30 can be configured as another type of fastening means, such as, e.g., a bayonet mount (catch), a central retaining nut, an expanding mandrel, or another type of quick-coupling mechanism, which are each configured to hold the cover plate 27 and the blade carrier 21 together with the cutting blades 23 disposed between them. In such modifications of the mounting aid, a screw-fastening of the cover plate 27 to the blade carrier 21 using the screw 35 may not be necessary, and thus the screw 35 can be omitted in some modifications of the present teachings. In a state attached to the base module 10, the cover plate 27 is also held on the blade carrier 21 by the screws 37 in the above embodiment.

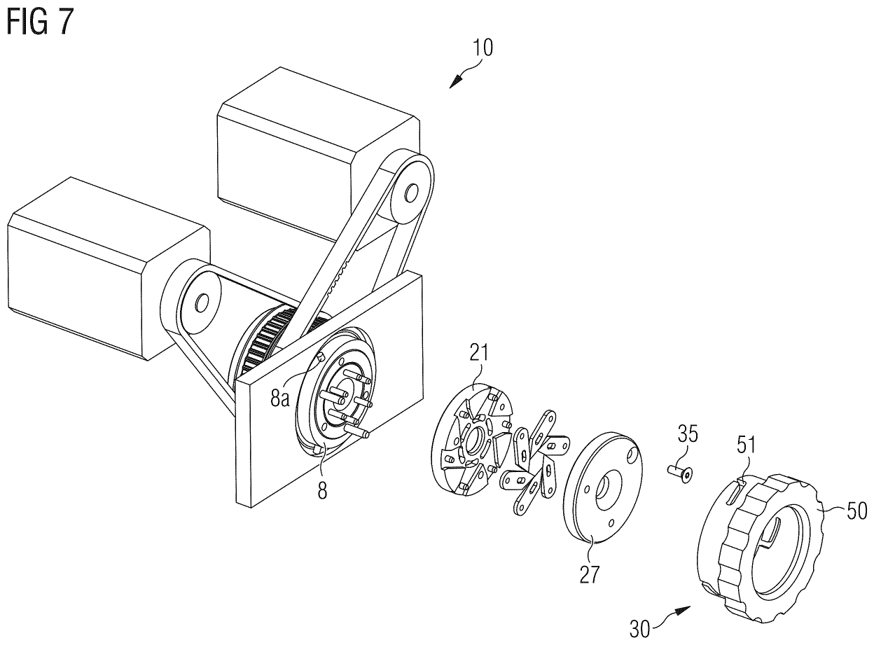

A mounting aid 30 configured as a bayonet mount is shown in FIG. 7. In the embodiment shown in FIG. 7, the first drive shaft 8 is configured as a cylindrical male side of the bayonet mount and has one or more radially-extending pins 8a (in the present embodiment three). An annular female receptor 50 has an equal number of approximately L-shaped slots 51 (i.e. in the present embodiment three). To detachably mount the female receptor 50 on the first drive shaft 8, the pins 8a are respectively aligned with the openings of the approximately L-shaped slots 51, the female receptor 50 is pushed towards the first drive shaft 8 and then rotated clockwise to fix the female receptor 50 to the first drive shaft 8. The mounting aid 30 shown in FIG. 7 may be used in combination with the mounting aid 30 shown in FIGS. 1 and 2. The screws 37 may be omitted.

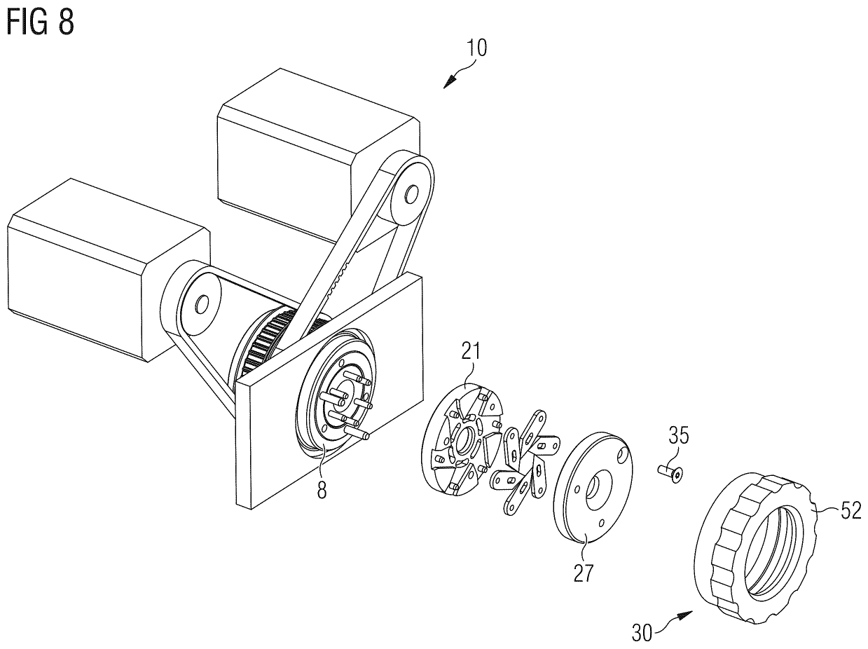

A mounting aid 30 configured as a central retainer nut 52 is shown in FIG. 8. In the embodiment shown in FIG. 8, the first drive shaft 8 has a male thread on its outer circumferential surface. The central retainer nut 52 has a female thread on its inner circumferential surface and is mounted on the first drive shaft 8 by screwing the female thread onto the corresponding male thread. The mounting aid 30 shown in FIG. 8 may be used in combination with the mounting aid 30 shown in FIGS. 1 and 2. The screws 37 may be omitted.

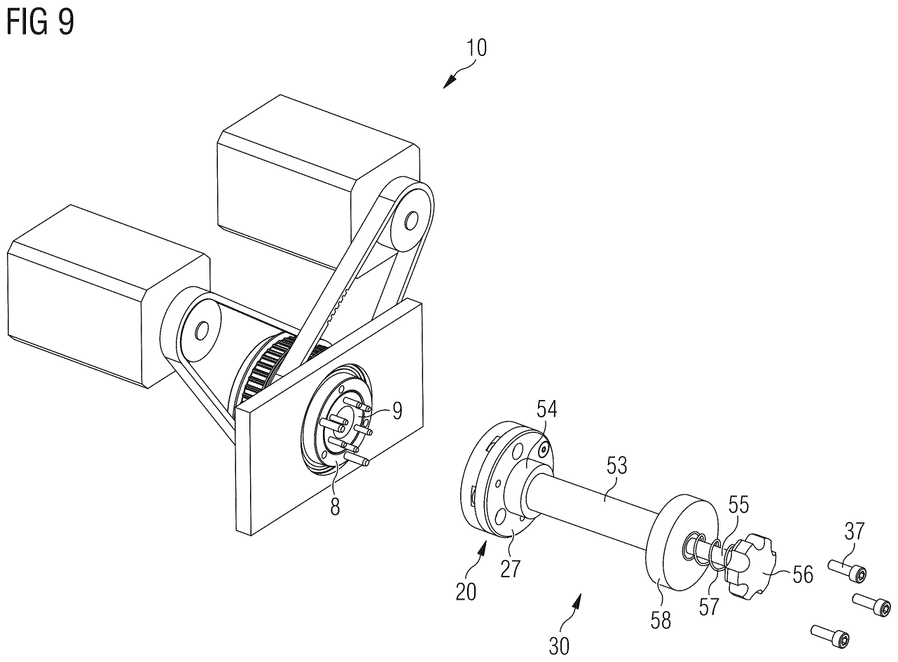

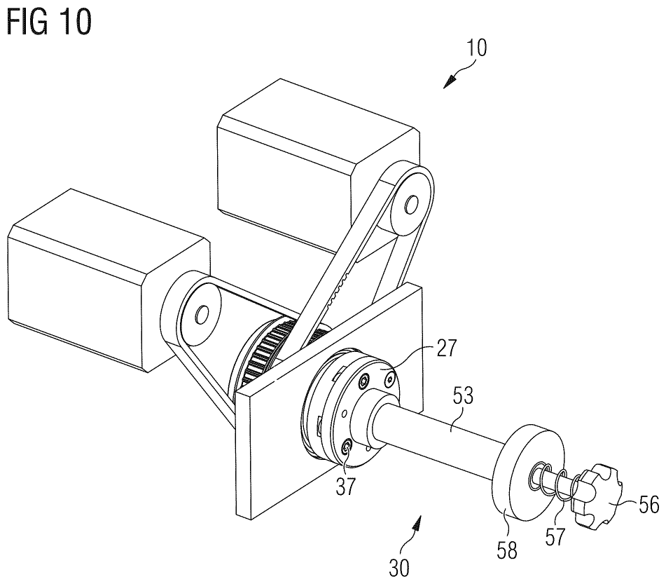

A mounting aid 30 configured as an expanding mandrel is shown in FIGS. 9, 10, 11a and 11b. In the embodiment shown in these Figures, the blade cassette 20 is screw-fastened to the first drive shaft 8 with screws 37. The expanding mandrel includes a cylinder 53 having an annular stop (flange) 54 that abut against the cover plate 27. A rotatable shaft 55 is disposed within the cylinder 53 so as to be linearly movable within the cylinder 53. A knob 56 is affixed at one end of the shaft 55 and can be grasped to push/pull, and thereby move, the shaft 55 within (relative to) the cylinder 53. A compression spring 57 abuts against a collar 58 affixed to the shaft 55 and urges (biases) the knob 56 in the direction away from the cover plate 27.

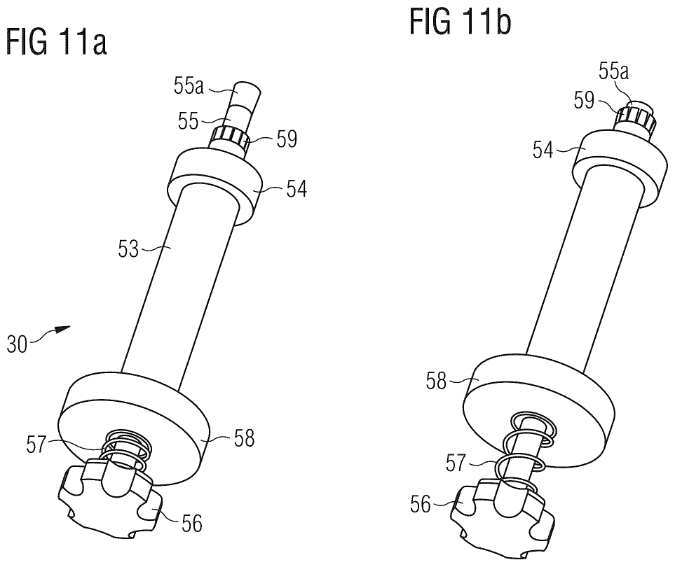

As can be seen in FIG. 11a, the shaft 55 has a flared end 55a on the longitudinal end opposite of the knob 56. In the state in which the shaft 55 is pushed towards the cover plate 27 as shown in FIG. 11a, the flared end 55a is spaced apart from an expandable mandrel (expandable radial flange) 59, such that the expandable mandrel 59 assumes its smallest outer diameter. On the other hand, in the state in which the shaft 55 is pushed away the cover plate 27 (by the compression spring 57) as shown in FIG. 11b, the flared end 55a is disposed within the expandable mandrel 59, such that the expandable mandrel 59 assumes its smallest largest diameter.

Thus, in the state in which the mounting aid 30 of this modification is attached the cover plate 27, the shaft 55 and expandable mandrel 59 are inserted along the rotational axis x into the through hole 27a of the cover plate 27, into the space formed between the cutting edges 24 of the cutting blades 23 and into the through hole 21a of the blade carrier 21. In this state, the compression spring 57 urges knob 56 in the direction away from the cover plate 27 such that the flared end 55a is disposed within the expandable mandrel 59, thereby causing the expandable mandrel 59 to expand. Thus, the blade cassette 20 can be removed from the base module 10 using the mounting aid 30 attached to the blade cassette 20 while the cutting blades 23 are held in their position, e.g., in the home position, by the expanded mandrel 59. To remove the blade cassette 20 from the mounting aid 30, the knob 56 is pushed towards the cover plate 27, whereby the flared end 55a is pushed out of the expandable mandrel 59. In this state, the (now smaller) expandable mandrel 59 can be pulled out of the blade cassette 20 so that the blade cassette 20 can be serviced.

The cover plate 27 is not absolutely necessary and can be omitted. The cutting blades 23 can be directly secured/held on the blade carrier 21, and the blade carrier 21 can be directly secured/held on the base module 10.

The blade cassette 20 need not necessarily be attached to the base module 10 using the screws 37. For example, the driver pins 12 can extend through holes in the cover plate 27, and ends of the driver pins 12 can be provided with threads, onto which nuts are screwed.

The number of screws 37, through holes 37a, 38 and threaded holes 13 is not limited to three. The number of screw(s) 35, through hole(s) 39 and threaded hole(s) 34 is not limited to one. The number of driver pins 12 and mounting holes 28 is not limited to two.

In the embodiment shown in FIGS. 1 and 2, the mounting aid 30 has the pin 31 for positioning the cutting blades 23 in the home position. Alternatively/additionally, the mounting aid 30 can have one or more positioning pins 33 (see FIG. 6b), which are configured to engage through the cover plate 27 into the slotted holes 26 of the cutting blades 23, in particular at the other end of the slotted holes 26 than the guide pins 11 in the home position. This enables a problem-free usage of the cutting blades 23, which become smaller when repeatedly resharpened. Alternatively, the positioning pins 33 of the mounting aid 30 can fix the cutting blades 23 in a desired position at another uncritical point.

The magnets 32 are not absolutely necessary for fastening the mounting aid 30 of FIGS. 1 and 2 to the blade cassette 20. Alternatively/additionally, other fastening means, such as, e.g., one or more screws, can be used. As was explained above, in alternate embodiments according to the present teachings, the mounting aid 30 can be attached to the blade cassette 20 using the above-described bayonet mount (catch), central retaining nut or expanding mandrel.

With regard to the attachment means, the positions of the driver pins 12 and the mounting holes 28 can be interchanged. For example, the driver pins 12 can be provided on a surface of the blade carrier 21 that faces the first drive shaft 8 and can project parallel to the rotational axis x in the direction of the first drive shaft 8, and the mounting holes 28 can be formed in a surface of the first drive shaft 8 that faces the blade carrier 21.

The driver pins 12 and the mounting holes 28 can be omitted. In this case, the blade cassette 20 can be attached and positioned on the first output shaft 8 by the screws 37, the through holes 37a, 38 and the threaded holes 13, which serve as attachment means in such an embodiment.

Alternatively/additionally to the driver pins 12, other attachment means, such as protrusions, can be used. The same applies to the guide pins 11.

The positions of the guide pins 11 and the slotted holes 26 can be interchanged. For example, the guide pins 11 can be provided on surfaces of the cutting blades 23 that face the blade carrier 21 or the second drive shaft 9 and project parallel to the rotational axis x through the slotted holes 29 in the blade carrier 21 in the direction of the second drive shaft 9, and the slotted holes 26 can be formed in a surface of the second drive shaft 9 that faces the blade carrier 21.

The slotted holes 26 can be configured as straight or curved guide slots.

The positions of the bearing pins 22 and the holes 25 can be interchanged. For example, the bearing pins 22 can be provided on surfaces of the cutting blades 23 that face the blade carrier 21, and the holes 25 can be formed in a surface of the blade carrier 21 that faces the cutting blades 23.

The positions of the first and second drive shafts 8, 9 can be interchanged. The first drive shaft 8 can extend inside the second drive shaft 9. In this case, the positions of the mounting holes 28, the through holes 38, the slotted holes 26, 29, the bearing pins 22 and the holes 25 may have to be adjusted accordingly. For example, the holes 25 can be provided in a central region of the cutting blades 23 along their respective longitudinal extension direction, and the bearing pins 22 can be provided at corresponding positions. The slotted holes 29 can be located in a radially outer region of the blade carrier 21, and the slotted holes 26 can be arranged at corresponding positions in the cutting blades 23. The mounting holes 28 and the through holes 38 can be located radially farther inwards than the slotted holes 29.

The mounting holes 28 can, for example, be configured as through holes or as blind holes. If the mounting holes 28 are configured as through holes in the blade carrier 21, holes (through holes or blind holes) can also be formed in the cover plate 27 at locations corresponding to the mounting holes 28 that receive the driver pins 12.

The blade carrier 21 can, for example, pivotably support two or more, e.g., three or four or six or eight, cutting blades 23.

The driving of the first and second drive shafts 8, 9 need not take place via the belts 6, but rather can, for example, take place via gear wheels. The housing 7 need not have the plate shape shown in FIGS. 1 and 2, but rather can have a different shape that enables suitable supporting of the first and second drive shafts 8, 9.

As an alternative to the embodiment having two drive motors 5, the two drive shafts 8, 9 can be driven by one drive motor, analogous to the technology disclosed in WO 2020/119916 A1, wherein a servomotor rotates the drive shafts 8, 9 relative to one another.

Additional aspects of the present disclosure include, but are not limited to:

1. Stripping device (1) for stripping cables, including:
a base module (10) having a housing (7) and two drive shafts (8, 9) that are coaxially supported on the housing (7), extend in one another and are rotatable relative to the housing (7) and to one another; and
a blade cassette (20) including
   a blade carrier (21) that is detachably attachable to an end of a first (8) of the two drive shafts of the base module (10), and
   a cutting blade (23) that has a cutting edge (24) facing in the direction of the rotational axis (x) for cutting into an insulation and that is attached to the blade carrier (21) at a pivot point (22, 25) in order to be pivotable about a pivot axis (v) parallel to the rotational axis (x),
wherein
the blade carrier (21) and the first drive shaft (8) have attachment means (12, 28) for detachably attaching the blade carrier (21) to the first drive shaft (8) at a predetermined rotational position relative to the first drive shaft (8),
the cutting blade (23) or the second drive shaft (9) has a guide slot (26) for engaging a guide element (11) that is provided on the other of the cutting blade (23) and the second drive shaft (9), and
the cutting blade (23) is pivotable towards the rotational axis (x) and away from the rotational axis (x) by rotation of the second drive shaft (9) relative to the first drive shaft (8) and to the blade carrier (21) and a resulting movement of the guide element (11) along the guide slot (26) relative to the blade carrier (21).

2. Stripping device (1) according to the above Aspect 1, wherein
the first and second drive shafts (8, 9) are rotatably supported on the housing (10) also in a state in which the blade cartridge (20) is not attached to the base module (10), and/or
the blade cassette (20) is supported on the housing (7) exclusively via the first and/or the second drive shaft (8, 9).

3. Stripping device (1) according to the above Aspect 1 or 2, wherein
the first and second drive shafts (8, 9) are supported in one another, and/or
the blade carrier (21) has an opening (21a) along the rotational axis (x) for passage of a cable.

4. Stripping device (1) according to one of the above Aspects 1 to 3, wherein
the blade carrier (21) or the first drive shaft (8) has a driver hole or attachment hole (28) or a driver groove for engaging a driver pin (12) that is provided on the other of the blade carrier (21) and the first drive shaft (8) and that extends parallel to the rotational axis (x), and/or
the guide element (11), which is provided on the cutting blade (23) or the second drive shaft (9), is configured as a guide pin (11) that extends parallel to the rotational axis (x), and/or
the guide slot (26) is configured as a curved or straight slotted hole.

5. Stripping device (1) according to one of the above Aspects 1 to 4, wherein
the blade cassette (20) has a plurality of cutting blades (23), in particular two, three, four, six or eight cutting blades (23), and/or
the blade carrier (21) and the first drive shaft (8) each have a plurality of attachment means (12, 28).

6. Stripping device (1) according to one of the above Aspects 1 to 5, wherein the blade cassette (20) is attachable to the first drive shaft (8) of the base module (10) using a central retainer nut.

7. Stripping device (1) according to any one of the above Aspects 1 to 6, wherein
the blade cassette (20) further includes a cover plate (27),
the cover plate (27) has an opening (27a) along the rotational axis (x) for passage of the cable,
the cutting blade (23) is provided between the blade carrier (21) and the cover plate (27), and/or
the cover plate (27) is fastened, in particular screw-fastened, to the blade carrier (21).

8. Base module (10) for a stripping device (1) according to one of the above Aspects 1 to 7, including a housing (7) and two drive shafts (8, 9) that are coaxially supported on the housing (7), extend in one another and are rotatable relative to the housing (7) and to one another, wherein
a first (8) of the two drive shafts includes an attachment means (12) for releasably attaching a blade carrier (21) to an end of the first drive shaft (8) at a predetermined rotational position relative to the first drive shaft (8), and
the second drive shaft (9) has a guide slot (26) or a guide element (11) for pivoting the cutting blade (23) of the blade cassette (20).

9. Blade cassette (20) for a stripping device (1) according to one of the above Aspects 1 to 7, comprising
a blade carrier (21) that is detachably attachable to an end of a first (8) of the two drive shafts of the base module (10) of the stripping device (1), and
a cutting blade (23) that has a cutting edge (24) facing in the direction of the rotational axis (x) for cutting into an insulation and is attached to the blade carrier (21) at a pivot point (22, 25) in order to be pivotable about a pivot axis (v) parallel to the rotational axis (x),
wherein
the blade carrier (21) includes an attachment means (28) for detachably attaching the blade carrier (21) to the first drive shaft (8) at a predetermined rotational position relative to the first drive shaft (8),
the cutting blade (23) has a guide slot (26) or a guide element (11) configured to be brought into engagement with a guide element (11) or a guide slot (26) that is provided on the second drive shaft (9), and
the cutting blade (23) is pivotable towards the rotational axis (x) and away from the rotational axis (x) by rotation of the second drive shaft (9) relative to the first drive shaft (8) and to the blade carrier (21) and a resulting movement of the guide element (11) along the guide slot (26) relative to the blade carrier (21).

10. Calibration station (40) for a blade cassette (20) according to the above Aspect 9, including:
an attachment unit having two shafts (48, 49) that extend coaxially in one another and are rotatable relative to one another, wherein
   the first shaft (48) includes an attachment means (12) for releasably attaching the blade carrier (21) to an end of the first shaft (48) at a predetermined rotational position relative to the first shaft (48), and
   the second shaft (9) has a guide slot (26) or a guide element (11) for pivoting the cutting blade (23); and
a scale (41) for indicating a rotational position of the second shaft (49) relative to the first shaft (48).

11. System including:
a stripping device (1) according to one of the above Aspects 1 to 7;
a calibration station (40) according to the above Aspect 10; and
a plug gauge (42) that is configured to be inserted into the blade cassette (20) along the rotational axis (x) instead of a cable and to contact the cutting edge (24) of the cutting blade (23).

12. Mounting aid (30) for a stripping device (1) according to any one of the above Aspects 1 to 7, including:
a central pin (31) configured to be inserted along the rotational axis (x) into the opening (21a) in the blade cassette (20) and to contact the cutting edge (24) of the cutting blade (23); and/or
a positioning pin (33) configured to be inserted into the guide slot (26) of the cutting blade (23) and to fix the cutting blade (23) at a specific position.

13. Mounting aid (30) according to the above Aspect 12, further including a magnet (32) that is configured to hold the mounting aid (30) on the blade cassette (20).

14. Mounting aid (30) according to the above Aspect 12 or 13 for a stripping device (1) according to the above Aspect 7, further including a quick-coupling mechanism, in particular an expanding mandrel or a bayonet mount (catch), which is configured to hold the cover plate (27) and the blade carrier (21) together.

15. System including a stripping device (1) according to one of the above Aspects 1 to 7 and a mounting aid (30) according to one of the above Aspects 12 to 14.

It is explicitly stated that all features disclosed in the description and/or claims are intended to be disclosed separately and independently of each other for the purpose of both the original disclosure and for the purpose of restriction of the claimed invention, irrespective of the combination of features in the embodiments and/or claims. It is explicitly stated that all value ranges or indications of groups of objects disclose every possible intermediate value or every possible object lying therebetween for the purpose of both the original disclosure and for the purpose of restriction of the claimed invention, in particular for determining the limits of value ranges.

1. A cable stripping device, including:
a base module having a housing and first and second drive shafts that are coaxially supported on the housing, extend coaxially in one another and are rotatable relative to the housing and to one another around a rotational axis; and
a blade cassette including a blade carrier that is detachably attachable to the first drive shaft, and at least one cutting blade having a cutting edge that faces the rotational axis, is configured to cut into an insulation of a cable and is attached to the blade carrier at a pivot point in order to be pivotable about a pivot axis that is parallel to the rotational axis,
wherein:
the blade carrier and the first drive shaft have attachment means that detachably attach the blade carrier to the first drive shaft at a predetermined rotational position relative to the first drive shaft,
one of the at least one cutting blade or the second drive shaft has a guide slot and the other of the at least one cutting blade or the second drive shaft has a guide element that engages in the guide slot, and
the at least one cutting blade is pivotable towards the rotational axis and away from the rotational axis in response to (i) rotation of the second drive shaft relative to the first drive shaft and to the blade carrier and (ii) a resulting movement of the guide element along the guide slot relative to the blade carrier.

2. The cable stripping device according to claim 1, wherein:
the first and second drive shafts are rotatably supported on the housing also in a state in which the blade cassette is not attached to the base module, and/or
the blade cassette is supported on the housing exclusively via the first and/or the second drive shaft.

3. The cable stripping device according to claim 1, wherein:
the first and second drive shafts are supported in one another, and/or
the blade carrier has an opening along the rotational axis for passage of a cable.

4. The cable stripping device according to claim 1, wherein:
one of the blade carrier or the first drive shaft has a mounting hole or a mounting groove configured to engage a driver pin that is provided on the other of the blade carrier and the first drive shaft and that extends parallel to the rotational axis, and/or
the guide element, which is provided on the cutting blade or the second drive shaft, is configured as a guide pin that extends parallel to the rotational axis, and/or
the guide slot is configured as a curved or straight slotted hole.

5. The cable stripping device according to claim 1, wherein:
the blade cassette has a plurality of cutting blades, and/or
the blade carrier and the first drive shaft each have a plurality of attachment means.

6. The cable stripping device according to claim 1, further comprising:
a central retainer nut that attaches the blade cassette to the first drive shaft.

7. The cable stripping device according to claim 1, wherein:
the blade cassette further includes a cover plate,
the cover plate has an opening along the rotational axis for passage of the cable,
the at least one cutting blade is disposed between the blade carrier and the cover plate, and/or
the cover plate is fastened to the blade carrier.

8. The cable stripping device according to claim 7, further comprising:
a quick-coupling mechanism selected from the group consisting of an expanding mandrel or a bayonet mount, which is configured to hold the cover plate and the blade carrier together.

9. The cable stripping device according to claim 1, further comprising a mounting aid having:
a central pin that is inserted along the rotational axis into a central opening in the blade cassette and contacts the cutting edge of the at least one cutting blade in order to position the at least one cutting blade in a specific position; and/or
a positioning pin configured to be inserted into the guide slot of the cutting blade and to fix the at least one cutting blade at the specific position.

10. The cable stripping device according to claim 9, further comprising:
a magnet configured to hold the mounting aid on the blade cassette.

11. The cable stripping device according to claim 1, wherein:
the first and second drive shafts are rotatably supported on the housing also in a state in which the blade cassette is not attached to the base module, and
the blade cassette is supported on the housing exclusively via the first and/or the second drive shaft.

12. The cable stripping device according to claim 11, wherein:
the first and second drive shafts are supported in one another, and
the blade carrier has a central opening along the rotational axis for passage of a cable.

13. The cable stripping device according to claim 12, wherein:
one of the blade carrier or the first drive shaft has a mounting hole configured to engage a driver pin that is provided on the other of the blade carrier and the first drive shaft and that extends parallel to the rotational axis,
the guide element, which is provided on the cutting blade or the second drive shaft, is configured as a guide pin that extends parallel to the rotational axis, and
the guide slot is configured as a curved or straight slotted hole.

14. The cable stripping device according to claim 13, wherein:
the blade cassette has a plurality of cutting blades, and
the blade carrier and the first drive shaft each have a plurality of attachment means.

15. A base module for the cable stripping device according to claim 1, comprising:
a housing; and
first and second drive shafts that are coaxially supported on the housing, extend coaxially in one another and are rotatable relative to the housing and to one another around a rotational axis,
wherein:
the first drive shaft includes an attachment means that releasably attaches a blade carrier to an end of the first drive shaft at a predetermined rotational position relative to the first drive shaft, and
the second drive shaft has a guide slot or a guide element for pivoting at least one cutting blade of a blade cassette.

16. A blade cassette for the cable stripping device according to claim 1, comprising:
a blade carrier that is detachably attachable to an end of one of first and second drive shafts of a base module of the cable stripping device; and
at least one cutting blade having a cutting edge that faces in the direction of a rotational axis of the first and second drive shafts, the at least one cutting blade being configured to cut into an insulation of a cable and being attached to the blade carrier at a pivot point in order to be pivotable about a pivot axis that is parallel to the rotational axis;
wherein:
the blade carrier includes an attachment means that detachably attaches the blade carrier to the first drive shaft at a predetermined rotational position relative to the first drive shaft,
the at least one cutting blade has a guide slot or a guide element configured to be brought into engagement with a guide element or a guide slot that is provided on the second drive shaft, and
the at least one cutting blade is pivotable towards the rotational axis and away from the rotational axis in response to (i) rotation of the second drive shaft relative to the first drive shaft and to the blade carrier and (ii) a resulting movement of the guide element along the guide slot relative to the blade carrier.

17. A calibration station for the blade cassette according to claim 16, including:
an attachment unit having first and second shafts that extend coaxially in one another and are rotatable relative to one another, and
a scale configured to indicate a rotational position of the second shaft relative to the first shaft,
wherein:
the first shaft includes an attachment means that releasably attaches a blade carrier to an end of the first shaft at a predetermined rotational position relative to the first shaft, and
the second shaft has a guide slot or a guide element for pivoting a cutting blade.

18. A system comprising:
a stripping device according to claim 1;
a calibration station; and
a plug gauge configured to be inserted into the blade cassette along the rotational axis instead of the cable and to contact the cutting edge of the at least one cutting blade to position the at least one cutting blade in a home position;
wherein the calibration station includes:
an attachment unit having first and second shafts that extend coaxially in one another and are rotatable relative to one another, and
a scale configured to indicate a rotational position of the second shaft relative to the first shaft, and
wherein:
the first shaft includes an attachment means that releasably attaches the blade carrier to an end of the first shaft at a predetermined rotational position relative to the first shaft, and
the second shaft has a guide slot or a guide element for pivoting the at least one cutting blade.
